(19) United States
(12) Patent Application Publication
(10) Pub. No.: US 2015/0311772 A1
(43) Pub. Date: Oct. 29, 2015

(54) SLIP RING DEVICE

(71) Applicants: TOYOTA JIDOSHA KABUSHIKI KAISHA, Toyota-shi, Aichi (JP); KABUSHIKI KAISHA TOYOTA JIDOSHOKKI, Kariya-shi, Aichi (JP)

(72) Inventors: Satoshi TOMINAGA, Susono-shi, Shizuoka-ken (JP); Takahiro SHIINA, Susono-shi, Shizuoka-ken (JP); Akira MURAKAMI, Gotenba-shi, Shizuoka-ken (JP); Hitoshi TAKAYAMA, Nagoya-shi, Aichi-ken (JP); Shu ASAMI, Nagoya-shi, Aichi-ken (JP); Takao WATANABE, Nagakute-shi, Aichi-ken (JP); Kiyoshi UETSUJI, Kariya-shi, Aichi-ken (JP); Shuji YUMOTO, Kariya-shi, Aichi-ken (JP); Hirofumi FUJIWARA, Kariya-shi, Aichi-ken (JP)

(73) Assignees: KABUSHIKI KAISHA TOYOTA JIDOSHOKKI, Kariya-shi, Aichi-ken (JP); TOYOTA JIDOSHA KABUSHIKI KAISHA, Toyota-shi, Aichi-ken (JP)

(21) Appl. No.: 14/647,978

(22) PCT Filed: Dec. 4, 2013
(86) PCT No.: PCT/JP2013/083145

§ 371 Date: May 28, 2015

(30) Foreign Application Priority Data
Dec. 4, 2012 (JP) 2012-265719

(51) Int. Cl. H02K 13/02; H01R 39/34; H01R 39/08

(52) U.S. Cl. CPC H02K 13/02; H01R 39/08; H01R 39/34

(57) ABSTRACT

There is provided a slip ring device in which three ring members through are provided so as to be lined up in sequence along an axial line of an input shaft and brushes contact with the ring members respectively, three inner bus bars are provided and are supported by a sleeve portion of the input shaft, and contacting groove portions are provided so as to dent in the radially outwards direction into the inner circumferential surfaces of the ring members and extend along the axial line direction, with one end portions of the inner bus bars being set into these contacting groove portions respectively.

### TECHNICAL FIELD

The present invention relates to a slip ring device that is provided with a plurality of ring members lined up in sequence along the axial direction of a rotation shaft.

### BACKGROUND ART

A rotating electrical machine in which a plurality of ring members are provided upon a rotation shaft so as to be lined up in sequence is per se known. One such rotating electrical machine is per se known in which an insulating member is provided around the external circumferential surface of the rotation shaft, the ring members are fixed upon the external circumferential surface of this insulating member, and bus bars are provided within the insulating member so that the one ends thereof contact the inner circumferential surfaces of the ring members (refer to Patent Literature 1).

### CITATION LIST

### Patent Literature

Patent Literature 1: Japanese Patent 3543500

### SUMMARY OF INVENTION

### Technical Problem

With the device of Patent Literature 1, the contact areas between the ring members and the bus bars are small, since only the one ends of the bus bars are in contact with the inner circumferential surfaces of the ring members. Due to this, it is difficult for heat to be conducted from the ring members to the bus bars, and accordingly there is a fear that the temperature of the ring members may become high.

Accordingly, the object of the present invention is to provide a slip ring device that is capable of promoting conduction of heat from the ring members to the bus bars, and that is thereby capable of keeping down the temperature of the ring members.

### Solution to Problem

A slip ring device of the present invention is a slip ring device comprising a plurality of ring members that are provided upon a rotation shaft so as to be lined up in sequence in an axial-line direction, each of the plurality of ring members being in contact with at least one brush, wherein the slip sing device further comprises a plurality of bus bars that are supported within the rotation shaft via an insulating member and extend along the axial-line direction, each of the plurality of bus bars being provided for each of the plurality of ring members, and wherein, on an inner circumferential surface of at least one of the ring members, a groove portion is provided, the groove portion being formed so as to extend along the axial-line direction and hollow outwards in a radial direction, and into the groove portion one end portion of the bus bar being set.

According to one aspect of the slip ring device of the present invention, since the end portion of the bus bar is set into the groove portion, accordingly it is possible to establish contact between the end portion of the bus bar and the ring member at a total of three surfaces within outer surface of the end portion of the bus bar: its one surface that faces outwards in the radial direction, and its two surfaces that face in the circumferential direction. Since, due to this, it is possible to increase the contact area between the bus bar and the ring member, accordingly it is possible to promote transfer of heat from the ring member to the bus bar. And, because of this, it is possible to reduce the temperature of the ring member. Moreover, due to this, it is also possible to reduce the temperature of the brushes that are in contact with the ring member. As is per se well known, the amount of wear upon the brush increases as the temperature of the brush becomes higher. Due to this, it is possible to reduce the amount of wear upon the brush by reducing the temperature of the brush. Moreover, by increasing the contact area between the bus bar and the ring member, it is possible to reduce the electrical resistance between these two members. Furthermore, by providing the groove portion in the inner circumferential surface of the ring member in this manner, it is possible to increase the thickness of the ring member towards its internal side by at least the depth of this groove portion. Since, due to this, it is possible to increase the volume of the ring member, accordingly it is possible to increase the thermal capacity of the ring member. And, due to this, even if for example the rotational speed of the rotation shaft suddenly increases, or if the amount of current applied to the ring member suddenly increases, still it is possible to suppress sudden elevation of the temperature of the ring member.

According to one embodiment of the present invention, a reception groove portion may be provided on the inner circumferential surface of a ring member of the plurality of ring members, an inward of the radial direction of the ring member the bus bar of another ring member passing through, the reception groove portion: being formed so as to extend in the axial-line direction and hollow outwards in the radial direction of the plurality of ring members; and receiving the bus bar of the another ring member via the insulating member. When the bus bar passes radially inward of the inner circumferential surface of the one ring member, it is necessary to provide an insulating member between the bus bar and the ring member, in order to mutually insulate the bus bar and the ring member from one another. In this case, with this aspect of the present invention, it is possible to make the insulating member that is provided at the inner circumference of the ring member thinner, since the bus bar that passes radially inward of the ring member can be received in the reception groove portion. Due to this, it is possible to reduce the thermal resistance between the ring member and the rotation shaft. And because of this it is possible to further reduce the temperature of the ring member and the temperature of the brush, since it is possible to enhance the heat dissipation performance of the ring member.

And, in the above embodiment, the rotation shaft may be provided in a three phase AC type rotating electrical machine; three ring members may be provided upon the rotation shaft; three of the bus bars may be provided around an axis of the rotation shaft so as to be separate from each other at angular separations of 120°; one of the groove portion and two of the reception groove portions may be provided in the inner circumferential surface of each of the ring members; one of the two reception groove portions may be arranged at a position spaced leftwards around the axis of the rotation shaft from the groove portion by an angular separation of 120°; and the other one of the two reception groove portions may be arranged at a position spaced rightwards around the axis of the rotation shaft from the groove portion by an angular separation of 120°. According to this aspect of the present invention, the shapes of the three ring members can all be the same. Due to this, it is possible to reduce the cost of manufacture. Moreover, by making all of the ring members have the same shape in this manner, it is possible to prevent the occurrence of errors during assembly, due to some component that is to be assembled in one position being mistakenly assembled into a different position.

### BRIEF DESCRIPTION OF DRAWINGS

FIG. 1 is a perspective view showing a portion of a compound motor to which a slip ring device according to a first embodiment of the present invention is installed.

FIG. 2 is a diagram showing a cross section of the neighborhood of the slip ring device in the axial direction.

FIG. 3 is a diagram showing a cross section of a slip ring device and an input shaft taken along line III-III in FIG. 4.

FIG. 4 is a diagram showing a cross section of the slip ring device and the input shaft taken along line IV-IV in FIG. 3.

FIG. 5 is a diagram showing a cross section of a slip ring device and an input shaft taken along line V-V in FIG. 6.

FIG. 6 is a diagram showing a cross section of the slip ring device and the input shaft taken along line VI-VI in FIG. 5.

FIG. 7 is a diagram showing a cross section of a slip ring device and an input shaft taken along line VII-VII in FIG. 8.

FIG. 8 is a diagram showing a cross section of the slip ring device and the input shaft taken along line VIII-VIII in FIG. 7.

FIG. 9 is a diagram showing a portion of a compound motor to which a slip ring device according to a second embodiment of the present invention is installed.

FIG. 10 is a diagram showing a cross section of the slip ring device and an input shaft taken along line X-X in FIG. 9.

FIG. 11 is a diagram showing a cross section of a slip ring device and an input shaft taken along line XI-XI in FIG. 12.

FIG. 12 is a diagram showing a cross section of the slip ring device and the input shaft taken along line XII-XII in FIG. 11.

FIG. 13 is a diagram showing a cross section of a slip ring device and an input shaft taken along line XIII-XIII in FIG. 14.

FIG. 14 is a diagram showing a cross section of the slip ring device and the input shaft taken along line XIV-XIV in FIG. 13.

FIG. 15 is a diagram showing a portion of a compound motor to which a slip ring device according to a third embodiment of the present invention is installed.

FIG. 16 is a diagram showing a cross section of the slip ring device and an input shaft taken along line XVI-XVI in FIG. 15.

FIG. 17 is a diagram showing a portion of a compound motor to which a slip ring device according to a fourth embodiment of the present invention is installed.

FIG. 18 is a diagram showing a cross section of the slip ring device and an input shaft taken along line XVIII-XVIII in FIG. 17.

### DESCRIPTION OF EMBODIMENTS

### First Embodiment

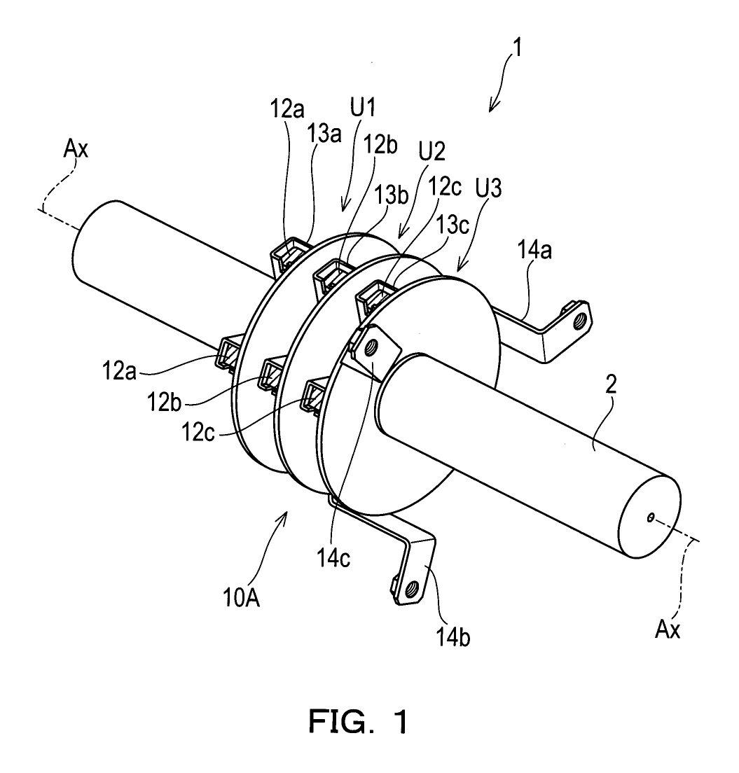

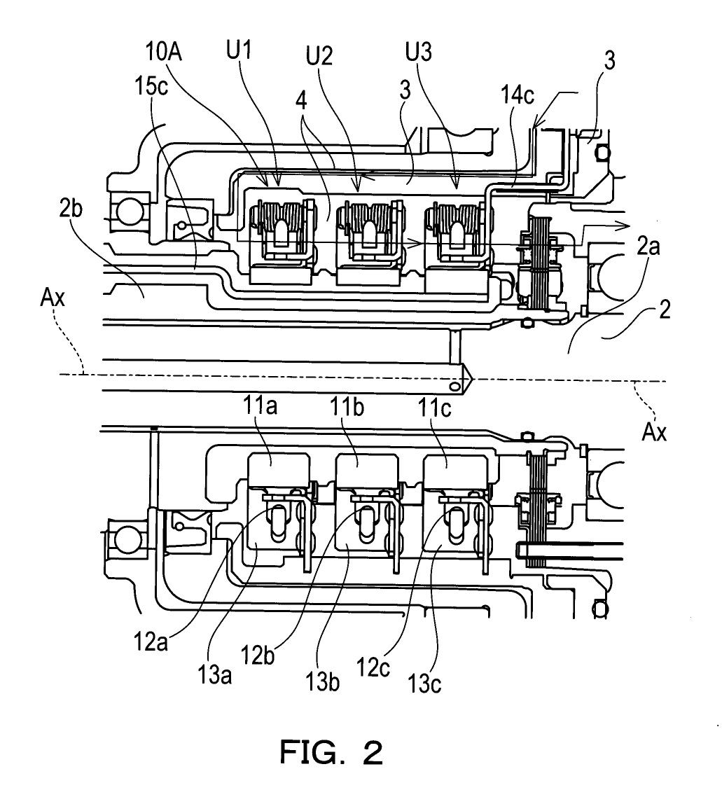

A slip ring device according to a first embodiment of the present invention will now be explained with reference to FIGS. 1 through 8. FIGS. 1 and 2 show a portion of a compound motor 1, which is a rotating electrical machine. This compound motor 1 is installed to a drive device for a vehicle such as an automobile or the like, not shown in the figures. Moreover, this compound motor 1 is a three-phase AC type motor. The compound motor 1 comprises a winding rotor and a magnet rotor that are capable of mutual relative rotation, although these are not shown in the figures. And this compound motor 1 is mounted between an internal combustion engine provided to the drive device and an automatic transmission (neither of which is shown), and serves a function of amplifying a torque of the engine that is inputted to the winding rotor and transmitting the torque amplified to the automatic transmission. The slip ring device 10A shown in FIGS. 1 and 2 is a three-phase AC type slip ring device, and is used for conducting current between the winding rotor and an inverter not shown in the figures. The slip ring device 10A is attached to the external circumferential surface of an input shaft 2, which is a rotation shaft that rotates integrally together with the winding rotor.

The slip ring device 10A includes three units U1 through U3 that correspond to the three phases of the winding rotor, and that are spaced apart in three stages with respect to a direction of an axial line Ax of the input shaft 2. In FIG. 2, a first stage unit U1 that is disposed at the left side of the three units comprises a ring member 11a that is installed around the external circumference of the input shaft 2, brushes 12a that contact with this ring member 11a, a brush holder 13a that holds and supports the brushes 12a, and an outer bus bar 14a that is connected with the brush holder 13a. While only some of the brushes 12a are shown in the figure, actually a total of six brushes 12a are provided to the single brush holder 13a, the six brushes being spaced apart at angular intervals of 60° around the axial line Ax. Naturally, the number of the brushes 12a could be chosen as desired. In a similar manner, a second stage unit U2 that is disposed in the center of the three units comprises a ring member 11b, brushes 12b, a brush holder 13b, and an outer bus bar 14b; and a third stage unit U3 that is disposed at the right side of the three units comprises a ring member 11c, brushes 12c, a brush holder 13c, and an outer bus bar 14c.

As shown in FIG. 2, the ring members 11a through 11c are provided coaxially to the outer circumferential surface of the input shaft 2. Moreover, these ring members 11a through 11c are provided so as to be lined up in sequence along the direction of the axial line Ax (i.e. along an axial-line direction). The brushes 12a through 12c that are supported by the brush holders 13a through 13c are pressed against the ring members 11a through 11c with predetermined pressing force by springs arranged between the brushes 12 and the brush holders 13, not shown in the figure. And each of the outer bus bars 14a through 14c extends outward from the input shaft 2 in a rotation radius direction, and also extends along the direction of the axial line Ax.

As shown in FIG. 2, the units U1 through U3 are covered over by a cover 3 that is made from resin, and are mutually insulated from one another. A cooling passage 4 is defined between the units U1 through U3 and the cover 3, for cooling the brushes 12a through 12c of the units U1 through U3 by leading air in a direction of an arrow in the figure. It will be understood that supply of air to this cooling passage 4 is performed by external air being forcibly blown into this cooling passage 4 by a component such as a fan or the like that rotates together with the input shaft 2.

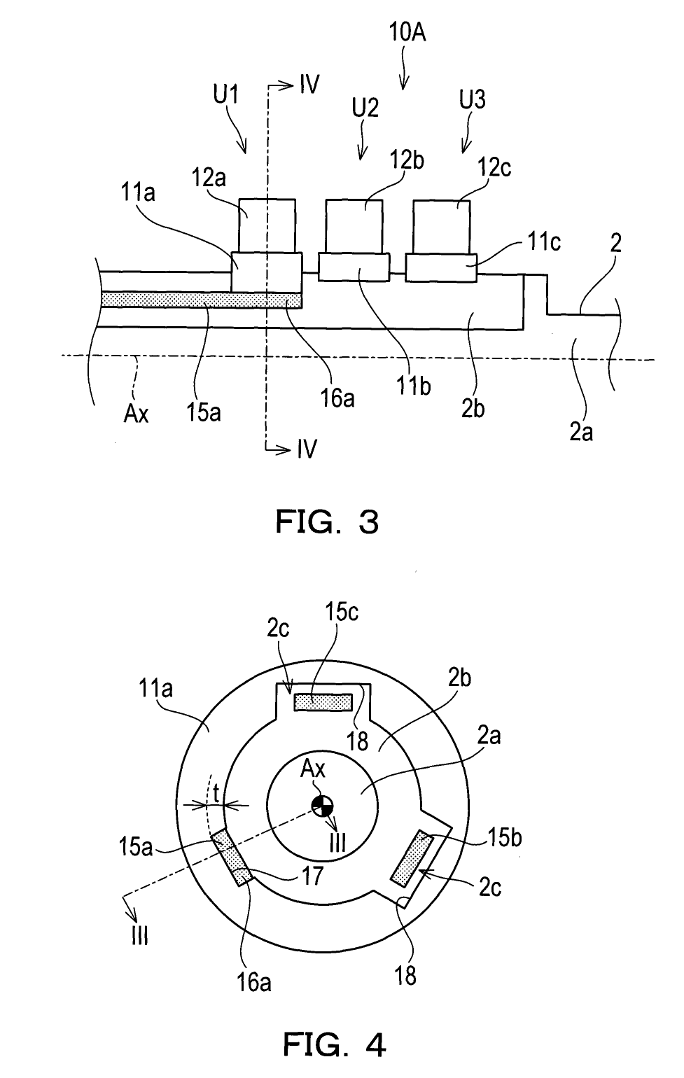

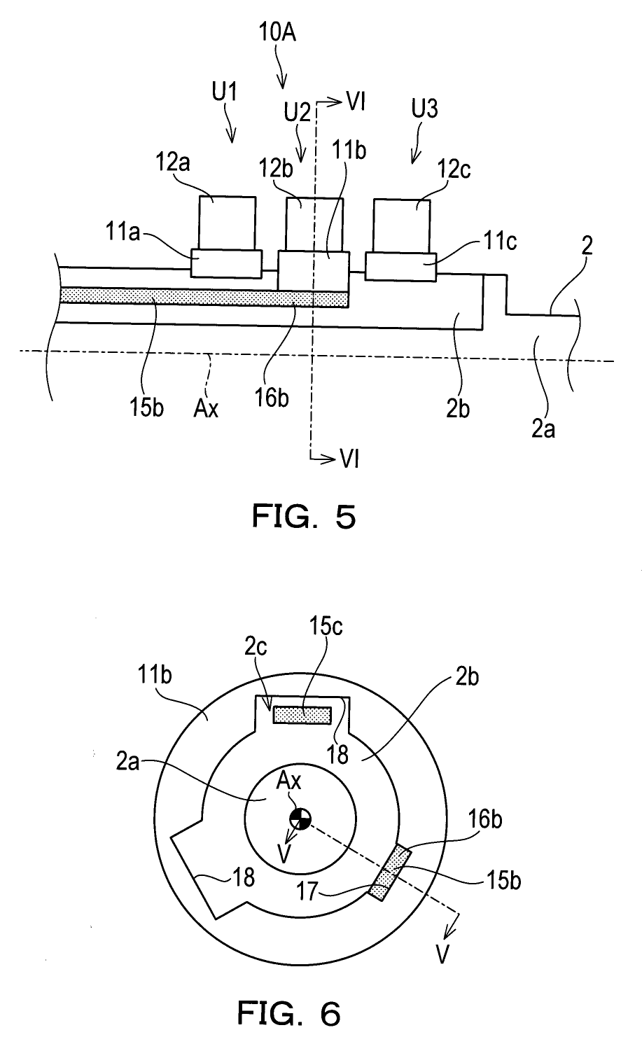

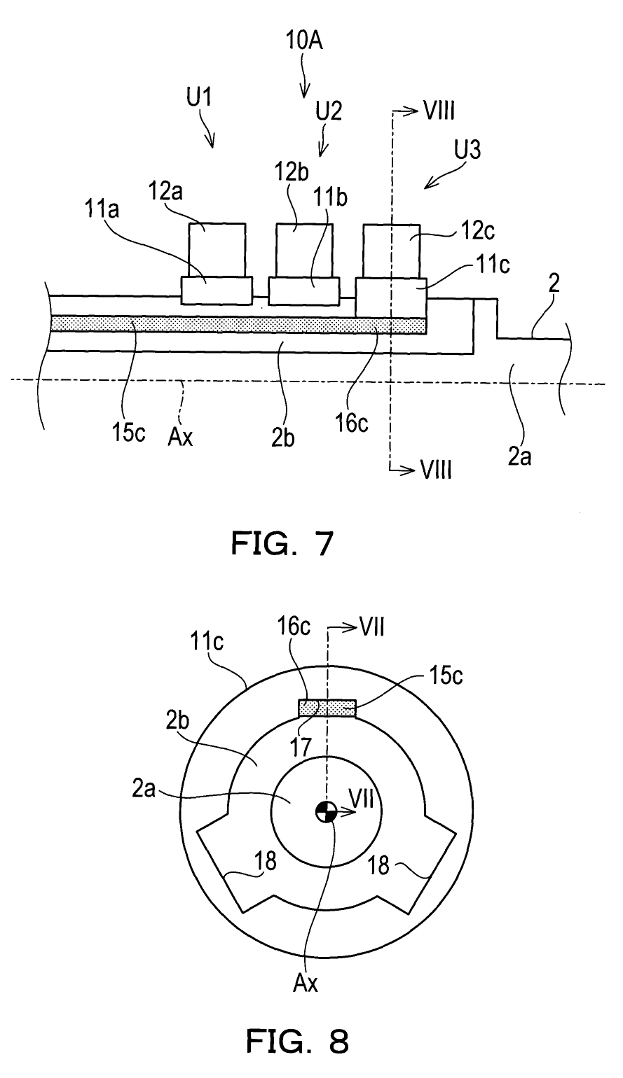

FIGS. 3 through 8 are sectional views of the slip ring device 10A and the input shaft 2. Here, FIG. 3 shows a cross section of the slip ring device 10A and the input shaft 2 taken along line III-III in FIG. 4, while FIG. 4 shows a cross section of the slip ring device 10A and the input shaft 2 taken along line IV-IV in FIG. 3. Moreover, FIG. 5 shows a cross section of the slip ring device 10A and the input shaft 2 taken along line V-V in FIG. 6, while FIG. 6 shows a cross section of the slip ring device 10A and the input shaft 2 taken along line VI-VI in FIG. 5. And FIG. 7 shows a cross section of the slip ring device 10A and the input shaft 2 taken along line VII-VII in FIG. 8, while FIG. 8 shows a cross section of the slip ring device 10A and the input shaft 2 taken along line VIII-VIII in FIG. 7. Furthermore, in FIGS. 4, 6, and 8, the brushes 12a through 12c are omitted.

As shown in these figures, the input shaft 2 comprises an inner shaft portion 2a that is made from metal, and a cylindrical sleeve portion 2b that is installed coaxially over the external circumference of the inner shaft portion 2a. This sleeve portion 2b is made from an insulating resin, which is an insulating material. Each of the ring members 11a through 11c is fixed upon the external circumference of the sleeve portion 2b, and they are spaced apart from one another. Due to this, each of the ring members 11a through 11c is mutually insulated from each other. Moreover, each of the ring members 11a through 11c is also insulated from the inner shaft portion 2a. As shown in FIGS. 3 through 8, inner bus bars 15a through 15c are provided inside the sleeve portion 2b. These inner bus bars 15a through 15c are provided so as to correspond to the ring members 11a through 11c respectively. Each of the inner bus bars 15a through 15c is shaped as a long narrow plate, and is supported within the sleeve portion 2b so as to extend in the axial-line direction. One end portions 16a through 16c of the inner bus bars 15a through 15c are contacted with the inner circumferential surfaces of the corresponding ring members 11a through 11c respectively, so that the bus bars 15a through 15c are electrically connected with the ring members 11a through 11c respectively. And, via each of the inner bus bars 15a through 15c, each of the ring members 11a through 11c is electrically connected to each of the phases of the winding rotor. As shown in FIG. 4, the three inner bus bars 15a through 15c are arranged around the axial line Ax at angular intervals of 120°.

As shown in FIGS. 4, 6, and 8, one contacting groove portion 17 and two reception groove portions 18 are provided upon the inner circumferential surface of each of the ring members 11a through 11c. Each of the groove portions 17 and 18 is formed so as to be hollow outwards in the radial direction, and to extend in the axial-line direction. Moreover, each of the groove portions 17 and 18 penetrates along the axial-line direction from one side surface of the ring member 11a through 11c to the other side surface thereof. As shown in these figures, one of the two reception groove portions 18 is formed at a position that is angularly spaced apart by 120° rightward from the contacting groove portion 17. On the other hand, the other of the two reception groove portions 18 is formed at a position that is angularly spaced apart by 120° leftward from the contacting groove portion 17.

As shown in these figures, each contacting groove portion 17 is formed so that each of the one end portions 16a through 16c of the corresponding inner bus bar 15a through 15c is set thereinto. Due to this, at the end of each of the bus bars 15a through 15c, a total of three surfaces contact with the corresponding one of the ring members 11a through 11c in its contacting groove portion 17: one of the three surfaces facing outwards in the radial direction; and two of the three surfaces facing in the circumferential direction. And each of the reception groove portions 18 is formed so as to be capable of receiving the corresponding one of the inner bus bars 15a through 15c via insulating resin 2c constituting part of the sleeve portion 2b. Due to this, the inner bus bar 15 that is received in each of the reception groove portions 18 of each of the ring members 11 is electrically insulated from the corresponding ring member 11. As shown in FIG. 4, at the inner circumference of the ring member 11a of the first stage unit U1, apart from the inner bus bar 15a of this unit U1 which is contacted to this ring member 11a as described above at its contacting groove portion 17, also the inner bus bar 15b of the second stage unit U2 and the inner bus bar 15c of the third stage unit U3 are provided. That is, the inner bus bar 15b of the second stage unit U2 is received in one of the two reception groove portions 18 of this ring member 11a, and also the inner bus bar 15c of the third stage unit U3 is received in the other one of the two reception groove portions 18. Moreover, as shown in FIG. 6, at the inner circumference of the ring member 11b of the second stage unit U2, apart from the inner bus bar 15b of this unit U2 which is contacted to this ring member 11b as described above at its contacting groove portion 17, also the inner bus bar 15c of the third stage unit U3 is provided. Because of this, the inner bus bar 15c of the third stage unit U3 is received in one of the two reception groove portions 18 of the ring member 11b. And only insulating resin is received in the other one of the two reception groove portions 18 of the ring member 11b. Furthermore, as shown in FIG. 8, at the inner circumference of the ring member 11c of the third stage unit U3, only the inner bus bar 15c of this unit U3 is contacted to this ring member 11c as described above at its contacting groove portion 17. And only insulating resin is received in the two reception groove portions 18 of the ring member 11c.

Since, as has been explained above, according to the slip ring device 10A of this first embodiment, the one end portions 16a through 16c of the inner bus bars 15a through 15c are set into the contacting groove portions 17 that are provided in the respective ring members 11a through 11c respectively, accordingly it is possible to increase the contact areas between the inner bus bars 15a through 15c and the corresponding ring members 11a through 11c. Due to this, it is possible to promote transfer of heat from the ring members 11a through 11c to the inner bus bars 15a through 15c. In this slip ring device 10A, when the input shaft 2 rotates, heat is generated due to friction between the ring members 11a through 11c and the brushes 12a through 12c. In this embodiment, it is possible to transfer this heat rapidly from the ring members 11a through 11c to the inner bus bars 15a through 15c. Because of this, it is possible to reduce the temperatures of the ring members 11a through 11c. Moreover, due to this, it is also possible to reduce the temperatures of the brushes 12a through 12c that are in contact with the ring members 11a through 11c. As is well known, the amounts of wear upon the brushes 12a through 12c increase more, as the temperatures of the brushes 12a through 12c are raised. Due to this, it is possible to reduce the amounts of wear upon the brushes 12a through 12c by decreasing the temperatures of the brushes 12a through 12c.

Furthermore, by increasing the contact areas between the inner bus bars 15a through 15c and their corresponding ring members 11a through 11c, it is possible to reduce electrical resistances between them. Due to this, it is possible to enhance efficiency of the compound motor 1.

Yet further, by setting the end portions 16a through 16c of the inner bus bars 15a through 15c into the contacting groove portions 17 in this manner, it is possible to increase thickness of the ring members 11a through 11c by the amount of thickness t shown in FIG. 4. Now, this thickness t shown in FIG. 4 corresponds to the depth of the contacting groove portion 17. Since, due to this, it is possible to increase the volumes of the ring members 11a through 11c, accordingly it is possible to increase the thermal capacities of the ring members 11a through 11c. Due to this, even if the rotational speed of the input shaft 2 suddenly increases, or if amounts of current transmitted to the ring members 11a through 11c suddenly increase, still it is possible to suppress sudden elevation of the temperatures of the ring members 11a through 11c.

In this embodiment, as shown in FIGS. 4 and 6, the reception groove portions 18 are provided to the ring members 11a through 11c, and the inner bus bars 15b and 15c of the units other than the unit in question are received in these reception groove portions 18. By contrast, if the reception groove portions 18 were not provided, then it would be necessary to make the thickness of the insulating resin mass that is provided at the inner circumferential surface side of the ring members greater, in order to allow passage of the inner bus bars further radially inward than the inner circumferential surface of the ring members. Accordingly, in this embodiment, it is possible to make the thickness of the insulating resin that is provided at the inner circumferential surface side of the ring members thinner. Due to this, it is possible to reduce the thermal resistances between the ring members 11a through 11c and the inner shaft portion 2a. Accordingly, it is possible to enhance heat dissipation performances of the ring members 11a through 11c. Because of this feature, it is possible further to reduce both the temperatures of the ring members 11a through 11c and the temperatures of the brushes 12a through 12c.

Since in this embodiment, as shown in FIG. 4, the inner bus bars 15a through 15c are arranged to be spaced apart from each other by 120°, accordingly it is possible to make the ring members 11a through 11c of the units U1 through U3 all of the same shape, as shown in FIGS. 4, 6, and 8. Due to this, it is possible to reduce the manufacturing cost. Moreover, by making the ring members 11a through 11c of the units U1 through U3 all of the same shape in this manner, it is possible to prevent occurrence of errors during assembly, due to some component that is to be assembled in one position being mistakenly assembled into a different position.

The contacting groove portion 17 corresponds to the groove portion(s) of the present invention, and the inner bus bars 15a through 15c correspond to the bus bar(s) of the present invention. Moreover, the sleeve portion 2b and the insulating resin 2c correspond to the insulating member of the present invention.

### Second Embodiment

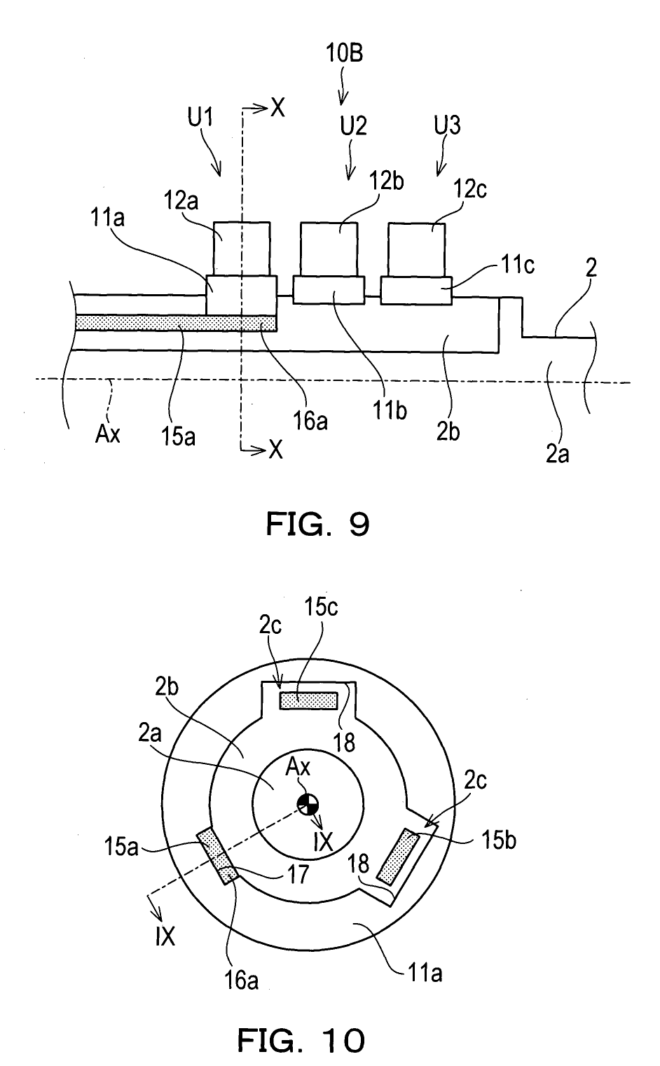

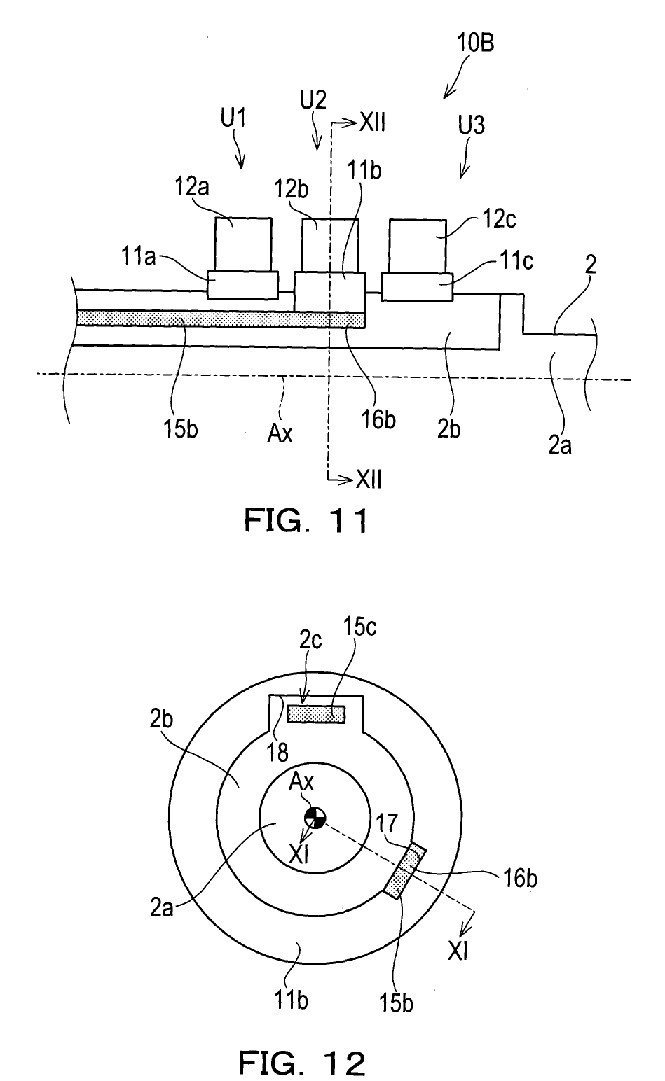

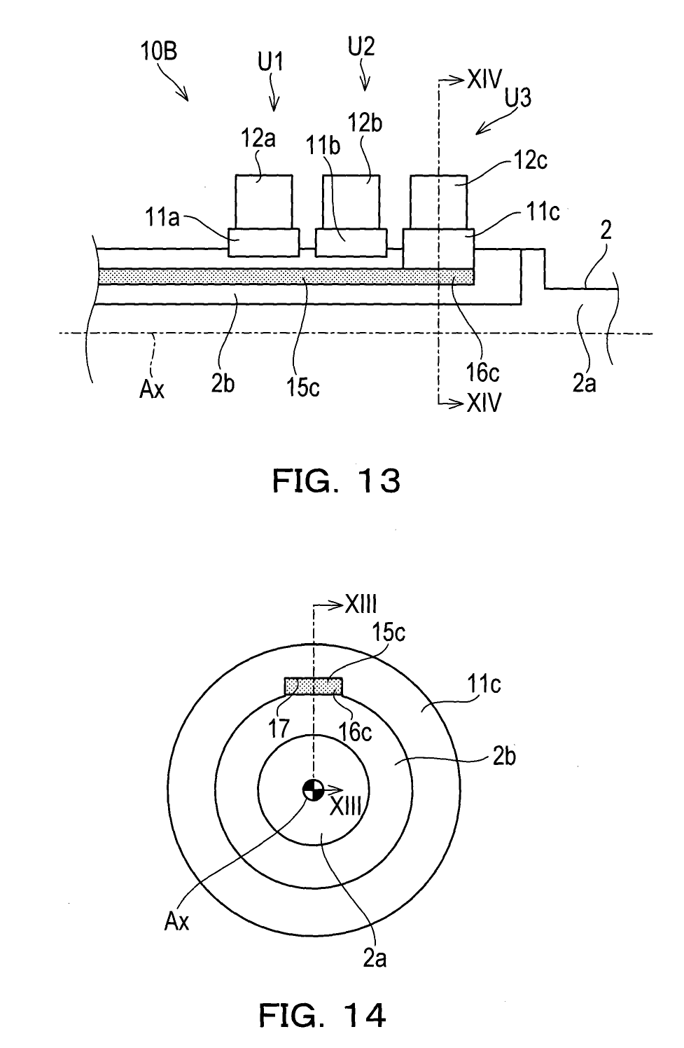

A slip ring device according to a second embodiment of the present invention will now be explained with reference to FIGS. 9 through 14. It should be understood that, in the description of this embodiment, to portions that are the same as ones in the first embodiment the same reference symbols will be appended, and description thereof will be omitted. These figures are sectional views of the slip ring device 10B and the input shaft 2 of this second embodiment. Here, FIG. 9 shows a cross section of the slip ring device 10B and the input shaft 2 taken along line IX-IX in FIG. 10, while FIG. 10 shows a cross section of the slip ring device 10B and the input shaft 2 taken along line X-X in FIG. 9. Moreover, FIG. 11 shows a cross section of the slip ring device 10B and the input shaft 2 taken along line XI-XI in FIG. 12, while FIG. 12 shows a cross section of the slip ring device 10B and the input shaft 2 taken along line XII-XII in FIG. 11. And FIG. 13 shows a cross section of the slip ring device 10B and the input shaft 2 taken along line XIII-XIII in FIG. 14, while FIG. 14 shows a cross section of the slip ring device 10B and the input shaft 2 taken along line XIV-XIV in FIG. 13. It should be understood that the brushes 12a through 12c are omitted from FIGS. 10, 12, and 14. As shown in these figures, in this second embodiment, the shape of the ring member lib of the second stage unit U2 and the shape of the ring member 11c of the third stage unit U3 are different from those in the first embodiment, while other features are the same as in the case of the first embodiment. Due to this, FIGS. 1 and 2 will also be referred to in the description of the compound motor 1 of this second embodiment as well.

As shown in FIG. 14, in this embodiment, only one contacting groove portion 17 is provided to the ring member 11c of the third stage unit U3. Moreover, as shown in FIG. 12, a single contacting groove portion 17 and a single reception groove portion 18 are provided to the ring member 11b of the second stage unit U2. Here, the inner bus bar 15c of the third stage unit U3 is received in the single reception groove portion 18.

As shown in FIG. 2, the environment surrounding the units U1 through U3 is not uniform. Due to this, when the input shaft 2 rotates and heat is generated by friction between the ring members 11a through 11c and the brushes 12a through 12c, temperature differences are set up between the units U1 through U3. Since the second stage unit U2 exists between the first stage unit U1 and the third stage unit U3, accordingly it can more easily incubate heat. In particular since, as shown in FIG. 2, the air that flows in the cooling passage 4 proceeds from the first stage unit U1 towards the third stage unit U3, accordingly, after having been warmed by exchanging heat with the first stage unit U1, the air is led to the second stage unit U2. And, after having been further warmed by exchanging heat with the second stage unit U2, the air is led to the third stage unit U3. Due to this it may be predicted that, in this slip ring device 10B, during rotation of the input shaft 2, in other words during operation of the compound motor 1, the temperatures of the first stage unit U1, the second stage unit U2, and the third stage unit U3 becomes higher in this order.

In this embodiment as well, similar beneficial operational effects can be obtained as in the case of the first embodiment described above. In addition thereto, in this embodiment, no reception groove portion 18 is provided in the ring member 11c of the third stage unit U3. Furthermore, only one reception groove portion 18 is provided in the ring member 11b of the second stage unit U2. Due to this, it is possible to reduce the volumes of insulating resin that are required to be provided at the inner circumference side of these ring members 11b and 11c. Because of this, it is possible further to promote transfer of heat from these ring members 11b and 11c to the inner shaft portion 2a. Accordingly, it is possible further to reduce the temperatures of the ring members 11b and 11c and the temperatures of the brushes 12b and 12c, of the second stage unit U2 and of the third stage unit U3 respectively.

As described above, it may be predicted that, during the operation of the compound motor 1, the temperatures of the first stage unit U1, the second stage unit U2, and the third stage unit U3 will become higher in this order. However, the volumes of insulating resin that are required to be provided at the inner circumference sides of the ring members 11a through 11c become less in the order from the first stage unit U1, through the second stage unit U2, to the third stage unit U3. Due to this, the thermal resistance between the ring member 11b of the second stage unit U2 and the inner shaft portion 2a becomes less than the thermal resistance between the ring member 11a of the first stage unit U1 and the inner shaft portion 2a. Moreover, also due to the above, the thermal resistance between the ring member 11c of the third stage unit U3 and the inner shaft portion 2a becomes less than the thermal resistance between the ring member 11b of the second stage unit U2 and the inner shaft portion 2a. For this reason, according to this second embodiment, it is possible to reduce the differences in temperature between the ring members 11a through 11c. And, due to this, it is possible to suppress variation in the amounts of wear between the brushes 12a through 12c, since it is possible to reduce the differences in temperature between the brushes 12a through 12c.

### Third Embodiment

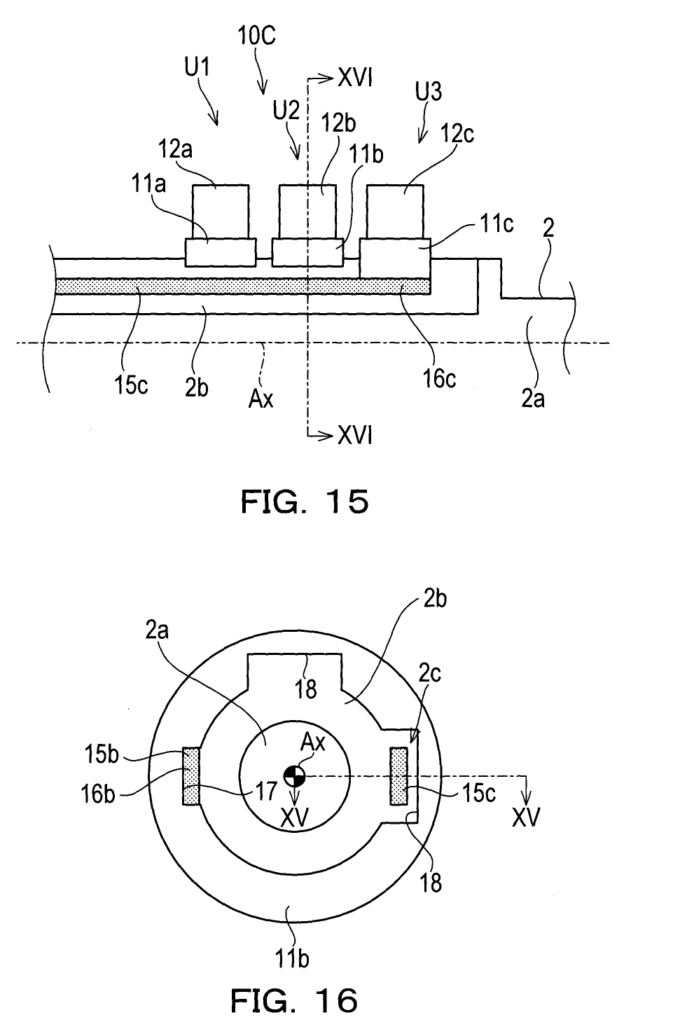

A slip ring device according to a third embodiment of the present invention will now be explained with reference to FIGS. 15 and 16. It should be understood that, in the description of this embodiment, to portions that are the same as ones in the first embodiment the same reference symbols will be appended, and description thereof will be omitted. FIG. 15 is a sectional view of the slip ring device 10C and the input shaft 2 of this third embodiment, taken in the axial-line direction. Moreover, FIG. 16 is a diagram showing a cross section of the slip ring device 10C and the input shaft 2 taken along lines XVI-XVI in FIG. 15. It should be understood that the brushes 12b are omitted from FIG. 16.

As shown in FIG. 16, in this third embodiment, the inner bus bar 15b of the second stage unit U2 is arranged to oppose the inner bus bar 15c of the third stage unit U3, with the axial line Ax lying between them. Although this feature is not shown in the figures, it should be understood that the inner bus bar 15a of the first stage unit U1 is arranged at a position at an angular separation of 90° rightward from the inner bus bar 15b of the second stage unit U2. And the contacting groove portions 17 and the reception groove portions 18 are provided in the ring members 11a through 11c at positions corresponding to the positions at which these inner bus bars 15a through 15c are arranged. Apart from the above, the configuration of this third embodiment is the same as that of the first embodiment described above.

Since, according to this third embodiment, the contacting groove portions 17 are provided to the ring members 11a through 11c, and the one end portions 16a through 16c of the inner bus bars 15a through 15c are set into these contacting groove portions 17, accordingly it is possible to promote transfer of heat from the ring members 11a through 11c to the inner bus bars 15a through 15c. Due to this, it is possible further to reduce the temperatures of the ring members 11a through 11c and the temperatures of the brushes 12a through 12c. Accordingly, it is possible to reduce the amounts of wear upon the brushes 12a through 12c. Moreover, since it is possible to increase the contact areas between the inner bus bars 15a through 15c and the ring members 11a through 11c, and thus to reduce the electrical resistances between them, accordingly it is possible to enhance the efficiency of the compound motor 1.

Furthermore, since in this third embodiment as well the reception groove portions 18 are provided to the ring members 11a through 11c, accordingly it is possible to reduce the thicknesses of the insulating resin masses that are provided at the inner circumference sides of the ring members. Due to this, it is possible to enhance the heat dissipation performances of the ring members 11a through 11c. Accordingly, it is possible to reduce the temperatures of the ring members 11a through 11c, and also to reduce the temperatures of the brushes 12a through 12c.

### Fourth Embodiment

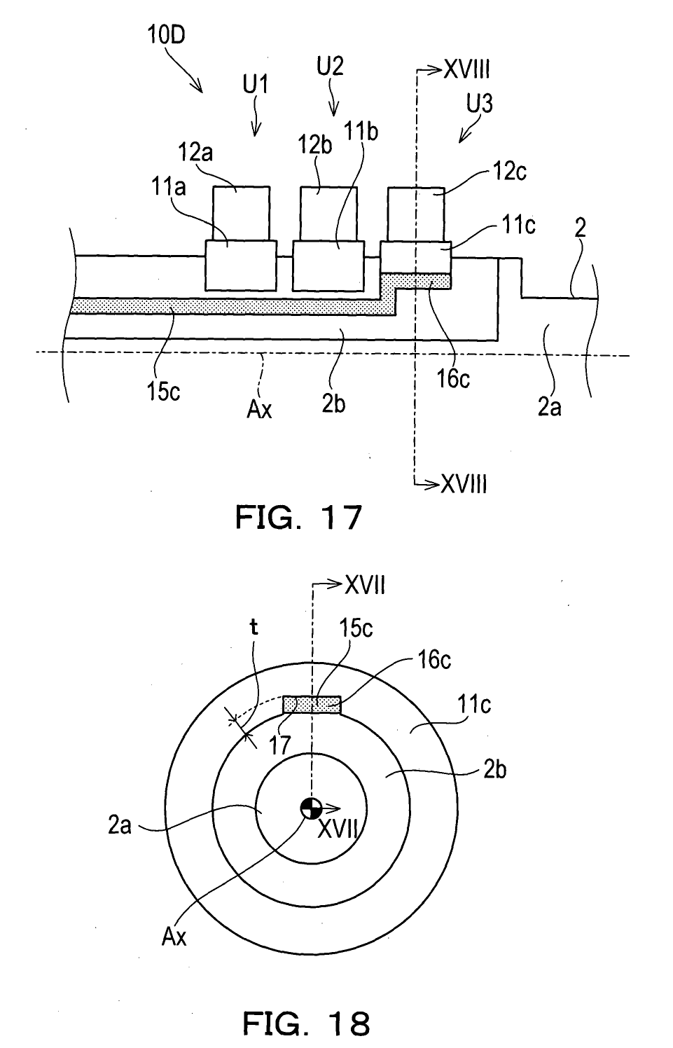

A slip ring device according to a fourth embodiment of the present invention will now be explained with reference to FIGS. 17 and 18. It should be understood that, in the description of this embodiment, to portions that are the same as ones in the first embodiment the same reference symbols will be appended, and description thereof will be omitted. FIG. 17 is a sectional view of the slip ring device 10D and the input shaft 2 of this fourth embodiment, taken in the axial-line direction. Moreover, FIG. 18 is a diagram showing a cross section of the slip ring device 10D and the input shaft 2 taken along line XVIII-XVIII in FIG. 17. It should be understood that the brushes 12c are omitted from FIG. 18.

As shown in FIG. 17, in this fourth embodiment, the one end portions 16a through 16c of the inner bus bars 15a through 15c are cranked so as to be positioned further radially outwards than the inner circumferential surfaces of the ring members 11a through 11c. And the contacting groove portion 17 is provided to each of the ring members 11a through 11c. However, no reception groove portions 18 are provided to the ring members 11a through 11c. Moreover, all of the ring members 11a through 11c have the same shape. In this embodiment as well, the end portions 16a through 16c of the inner bus bars 15a through 15c are set into the contacting groove portions 17 of the ring members 11a through 11c respectively.

Since, according to this fourth embodiment, as in the other embodiments described above, the one end portions 16a through 16c of the inner bus bars 15a through 15c are set into the contacting groove portions 17 of the ring members 11a through 11c, accordingly it is possible to promote transfer of heat from the ring members 11a through 11c to the inner bus bars 15a through 15c. Due to this, it is possible further to reduce the temperatures of the ring members 11a through 11c and the temperatures of the brushes 12a through 12c. Accordingly, it is possible to reduce the amounts of wear upon the brushes 12a through 12c. Moreover, since it is possible to increase the contact areas between the inner bus bars 15a through 15c and the ring members 11a through 11c, and thus to reduce the electrical resistances between them, accordingly it is possible to enhance the efficiency of the compound motor 1.

Yet further, by setting the end portions 16a through 16c of the inner bus bars 15a through 15c into the contacting groove portions 17 in this manner, it is possible to increase the thickness of the ring members 11a through 11c by the amount of the thickness t shown in FIG. 18. Since, due to this, it is possible to increase the thermal capacities of the ring members 11a through 11c, accordingly it is possible to suppress sudden elevation of the temperatures of the ring members 11a through 11c.

Furthermore since, with this fourth embodiment, it is possible to make all of the ring members 11a through 11c of the same shape, accordingly it is possible to reduce the cost of manufacture. Moreover, during assembly, it is also possible to prevent the occurrence of assembly errors.

The present invention is not to be considered as being limited to the embodiments described above; it could be implemented in many different ways. For example, the slip ring device to which the present invention is applied is not limited to being of the type that has three ring, members. In fact, the present invention could be applied to a slip ring device that has two or more ring members. Moreover, the number of brushes in the slip ring device of the present invention is not limited to being six for each of the ring members. The number of brushes provided to each of the ring members could also be any number from one through five. Moreover, it would also be possible to provide seven or more brushes to each of the ring members.

Finally, the device to which the slip ring device of the present invention is installed is not limited to being a three phase AC type rotating electrical machine. The slip ring device of the present invention could also be installed to a DC type rotating electrical machine, such as a DC motor or the like. Apart from the above, the slip ring device of the present invention could also be applied to any device that has a rotation shaft.

1. A slip ring device comprising a plurality of ring members that are provided upon a rotation shaft so as to be lined up in sequence in an axial-line direction, each of the plurality of ring members being in contact with at least one brush, wherein
the slip sing device further comprises a plurality of bus bars that are supported within the rotation shaft via an insulating member and extend along the axial-line direction, each of the plurality of bus bars being provided for each of the plurality of ring members, and wherein, on an inner circumferential surface of at least one of the ring members,
a groove portion is provided, the groove portion being formed so as to extend along the axial-line direction and hollow outwards in a radial direction, and into the groove portion one end portion of the bus bar being set, and
a reception groove portion is provided on the inner circumferential surface of a ring member of the plurality of ring members, an inward in the radial direction of the ring member the bus bar of another ring member passing through, the reception groove portion: being formed so as to extend in the axial-line direction and hollow outwards in the radial direction of the plurality of ring members; and
receiving the bus bar of the another ring member via the insulating member.

2. (canceled)

3. The slip ring device according to claim 1, wherein: the rotation shaft is provided in a three phase AC type rotating electrical machine;
three ring members are provided upon the rotation shaft;
three of the bus bars are provided around an axis of the rotation shaft so as to be separate from each other at angular separations of 120°;
one of the groove portion and two of the reception groove portions are provided in the inner circumferential surface of each of the ring members;
one of the two reception groove portions is arranged at a position spaced leftwards around the axis of the rotation shaft from the groove portion by an angular separation of 120°; and
the other one of the two reception groove portions is arranged at a position spaced rightwards around the axis of the rotation shaft from the groove portion by an angular separation of 120°.
